(19) United States
(12) Patent Application Publication
(10) Pub. No.: US 2013/0103687 A1
(43) Pub. Date: Apr. 25, 2013

(54) SIMULATION DEVICE AND PROGRAM FOR SAME

(71) Applicants: Yasuo Kakui, Kawasaki-shi (JP); Miki Kakui, Kawasaki-shi (JP)

(72) Inventors: Yasuo Kakui, Kawasaki-shi (JP); Miki Kakui, Kawasaki-shi (JP)

(21) Appl. No.: 13/703,849

(22) PCT Filed: Jun. 14, 2011
(86) PCT No.: PCT/JP2011/063998

§ 371 Date: Dec. 12, 2012

(30) Foreign Application Priority Data
Jun. 16, 2010 (JP) 2010-137597

(51) Int. Cl. G06F 17/30

(52) U.S. Cl. CPC G06F 17/30595
USPC 707/736

(57) ABSTRACT

Disclosed are a simulation device and a program for the same which make it possible to simulate whether the world is changing in a good direction or is changing in a bad direction by assessing the news. The impact relationship and degree of impact among a multitude of items representing change factors relating to nature and change factors due to human activity are created as a database and stored. In addition, current assessment values of good/bad are stored for each item as a database. News and items related to the news are distributed to a user terminal (UC) from a server device (SB). A user inputs an assessment value of good/bad with respect to the impact of the distributed news on the related items. The input user assessment value is transmitted to the server device (SB) and the current assessment values for the items having changed assessment values are updated from the impact relationship among the multitude of items and the degree of impact thereof.

### REFERENCE TO RELATED APPLICATIONS

This application is a national stage application under 35 USC 371 of International Application No. PCT/JP2011/063998, filed Jun. 14, 2011, which claims the priority of Japanese Application No. 2010-137597, filed Jun. 16, 2010, the entire contents of which are incorporated herein by reference.

### FIELD OF THE INVENTION

The present invention relates to a simulation device and a program for the same, said simulation device being adapted to be capable of simulating a direction of changes of the world by changes of the nature or the human activities.

### BACKGROUND OF THE INVENTION

Recently, simulations are performed in a variety of fields. Patent Document No. 1 discloses a simulation of training operators for operating trains.

Patent Document No. 1: Japanese Patent Publication No. 2007-72,224

The world in which humans live is changing in diverse directions by factors for changing the nature and human activities. For instance, in the event that costs of iron cores rise, the countries and companies producing them can make a profit resulting in changing in a good direction while countries and steel manufacturing companies consuming iron may suffer a loss due to a rise of costs of raw materials and iron products resulting in changing in a bad direction. Factors for changing the world by the nature may include, for example, temperature, moisture, an amount of rainfall, an amount of snowfall, hours of sunshine and many other factors. Factors for changing the world by the human activities may include, for example, a stock price mean, an exchange rate, a birth rate, an amount of fish catches and many other factors. These factors are all twisted and tangled with one another and link together in a complex way.

Changes of the nature and changes by the human activities may be generally provided extensively as news. Humans are sensitive to news of the field particularly in which they are interested. By accumulating assessments of such news as good ones or bad ones, however, it would be predicted in such a manner that the world would be changing in a good direction or in a bad direction. Making such a prediction may assist humans in reconsidering their routine life and serve as factors providing good guide to future activities.

With the foregoing matters taken into consideration, the present invention has been completed and the objects of the present invention are to provide a simulation device and a program for operating the same, said simulation device being adapted to be capable of simulating the world as changing in a good direction or in a bad direction by assessing news.

### DISCLOSURE OF THE INVENTION

In order to achieve the foregoing objects, the present invention provides a simulation device having the features as will be described below. The present invention as claimed in claim 1 is characterized by:

a memory means for saving as a database a current assessment value for a multitude of items as being good or bad, the items being set at least for one of changing factors in respect of the nature and changing factors by human activities, and a correlation of degrees of impact of an item to other items in a good or bad direction among the multitude of items;

a news provision means for providing a display screen of a user with a piece of news and an item related thereto among the multitude of items in a state in which the item related thereto is linked as a news-related item;

an assessment input means for entering a value of assessment value made by a user as to whether the news provided exerts a good or bad impact on the news-related item;

an assessment value renewal means for renewing the current assessment value for the news-related item on the basis of an assessment result entered and renewing the current assessment value for another item related to the news-related item on the basis of the assessment result and the degree of impact; and

an assessment display means for displaying the saved current assessment value on the display screen.

The solution means as described above enables an assessment of the provided news by assessing it whether it has a good or bad impact on a news-related item and assessing another item relating to the news-related item while taking degrees of impact between them into consideration. By accumulating such assessments, it may be made feasible to predict each one individual item of many items as to whether it is changing in a good direction or in a bad direction. At the same time, it may be made feasible to simulate the world constructed by a multitude of items or plural items as to whether it is changing in a good direction or in a bad direction as a whole.

In addition thereto, the present invention can demonstrate the merits and advantages as described hereunder. One of the merits and advantages may reside in that it is of an interactive nature because many users may assess a certain piece of news and consequently such assessments by other users are assessed by one another. The users participating in this simulation may become sensitive to news and the trend of the world, thereby resulting in receiving information on causes of an impact resulting in the world leading to a good direction or a bad direction and consequently obtaining a material (opportunity) assisting positively in altering the world in a good direction or in a bad direction. It is preferred as a matter of course that the effects achieved by the present invention may be demonstrated to a more sufficient extent as users may be able to attend to this simulation in an enjoyable fashion as if enjoying a game.

Preferred embodiments of the present invention to solve the problems residing therein are as described in claim 2 et seqq.

The simulation device according to a preferred embodiment of the present invention further comprises a mean assessment value determination means for determining a mean value of many assessment degrees of one piece of news from many users, wherein the mean assessment value determination means renews a current assessment value on the aforementioned mean value (corresponding to claim 2).

This simulation device is recommendable to obtain results of assessments with a high degree of persuasion without prejudice by simulating it on the basis of assessments made by many users.

The simulation device according to another preferred embodiment of the present invention further comprises the mean assessment value determination means for determining an mean value of a magnitude of assessment degrees of one piece of news from many users, wherein the database comprises an exclusive database saving the current assessment values exclusive for particular individual users and a common database saving the current assessment values for a multitude of users shared in common, and the assessment value renewal means is carried out for renewal of the current assessment values of the exclusive database on the basis of an input of the assessment degrees by each of the particular users and for renewal of the current assessment values of the common database on the basis of an input of assessment degrees by each of many shared users (corresponding to claim 3).

The simulation device of the present invention allows the assessment results by the particular users to be learned simultaneously together with the assessment results by the plural users shared in common, in addition to the assessment effects achieved by the present invention as claimed in claim 2.

Further, the simulation device according to the preferred embodiment of the present invention further comprises a virtual database saving the current assessment values on the basis of a piece of virtual news as the database and the assessment value renewal means renews the current assessment values for the virtual database at the time when the assessment degree of the virtual news is entered by the assessment input means (corresponding to claim 4).

This preferred embodiment is favored, for instance, in terms of obtaining a reviewing material from the assessment degree of the virtual news as to what activity may act on changing the world in a good direction.

The simulation device according to the preferred embodiment of the present invention further comprises a number of the user's terminals equipped each with the display screen, connected to the server device via the communication means; wherein:

A server device comprises the memory means, the news provision means and the assessment value renewal means;

news, news-related items and the current assessment values are transmitted to the user's terminals through the communication means from the server device; and

the degrees of assessment are transmitted through the communication means from the user's terminals (corresponding to claim 5).

This simulation device is preferred in respect of reducing a burden of the user's terminals by imposing a burden of a major function on the server device.

The simulation device according to the preferred embodiment of the present invention sets a multitude of factors for both of factors changing in respect to the nature and factors changing by human activities for each of many countries; wherein:

the correlation is set among a multitude of items for many countries; and the current assessment value is displayed by the assessment value display means in a manner displaying a portion of items for each country and displaying a multitude of items for one country (corresponding to claim 6).

This simulation device is favored in order to select the displaying manner for each country and the displaying manner for each item.

In order to achieve the objects described above, the present invention adopts a program for operating the simulation device as a solution technique in a manner as described hereunder, that is, as claimed in claim 7.

The program for operating the simulation device according to the present invention is designed to simulate the execution of a computer for simulating current assessment values of a multitude of items as to whether the items are good or bad, the items being set for at least one of the factors changing in respect to the nature and the factors changing by a human activity; wherein the program for the simulation device comprises:

the news provision step for providing the display screen with the news and an item related thereto among a multitude of items in a state in which it is linked to each other as a news-related item;

the assessment input reception step for receiving an input of a degree of assessment as to whether an impact of the provided news on the news-related item is good or bad;

the assessment value renewal step for renewing the current assessment value of the news-related item on the basis of the assessment result entered as well as renewing the current assessment value of another item related with the news-related item on the basis of the assessment result and the degree of impact by checking the database storing a correlation of degrees of impact of an item on another item among a multitude of items as to whether the impact of the item on the another item is good or bad impact; and

the display step for displaying the stored current assessment value on the display screen. This solution technique provides the program for the simulation device corresponding to claim 1.

A preferred embodiment for the above solution techniques is as described in claim 8. It provides the program for the simulation device further comprising:

the mean assessment value determination step for determining an mean assessment value of many degrees of assessments on one piece of news entered by many users, wherein:

the above database comprises an exclusive database storing the current assessment values set for the particular users only and a common database storing the current assessment values set for many users shared in common, and

the current assessment value renewal step is executed by renewing the current assessment value for the exclusive database on the basis of the input of the degree of impact by the particular user and the current assessment value for the common database based on the input of the degrees of impact by many users on the basis of the mean value determined by the mean assessment value determining step (corresponding to claim 8). This solution technique provides the program for the simulation device corresponding to claim 3.

The present invention enables users to simulate whether an individual item among a magnitude of items or the world constructed by a multitude of items is changing in a good direction or in a bad direction by making an assessment of the news.

### BRIEF DESCRIPTION OF THE DRAWINGS

FIG. 1 is a drawing showing an example of networks applicable to the present invention.

FIG. 2 is an illustration showing an example of main display screens.

FIG. 3 is a drawing showing relationships among many items.

FIG. 4 is a drawing showing an example of degrees of impact of telecommunications industry on each item.

FIG. 5 is a table showing a database saving degrees of impact of each item on other items.

FIG. 6 is a table showing a database saving current assessment values of each item.

FIG. 7 is a drawing showing an example of computing the value of a related item in accordance with a degree of impact when item X1 is assessed as α.

FIG. 8 is a graph showing an example of an assessment result (varied current assessment value) to be displayed on a display screen.

FIG. 9 is a graph showing another example of an assessment result (varied current assessment value) to be displayed on a display screen.

FIG. 10 is a flowchart showing a control example by a server device.

FIG. 11 is a flowchart showing another control example by a server device.

FIG. 12 is a flowchart showing another control example by a server device.

### MODES FOR CARRYING OUT THE INVENTION

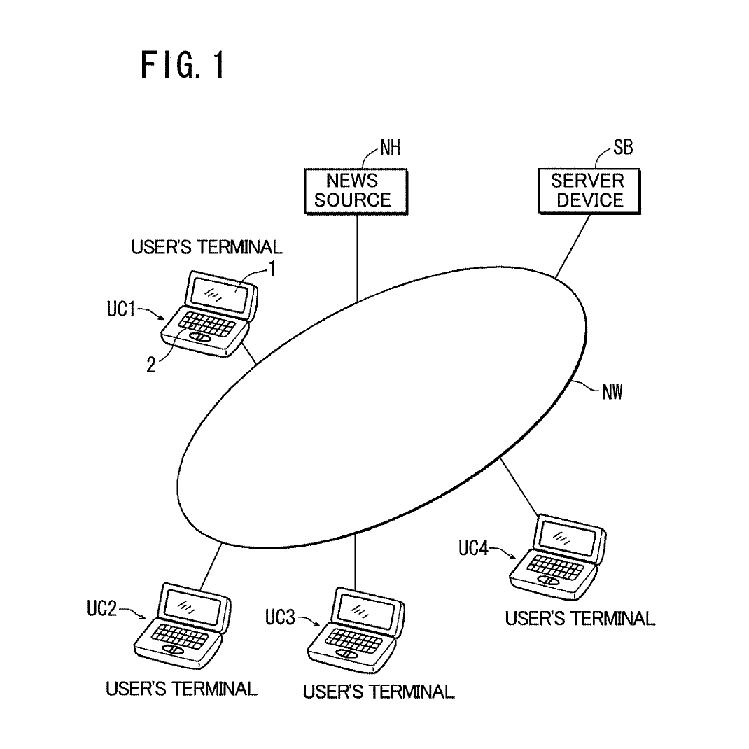

In FIG. 1, reference numeral 1 is intended to mean a network. In a working example, the network 1 denotes an internet, but it may be selected appropriately, for example, from leased lines such as telephone line and so on. To the network 1 are connected a server device SB composed of a computer, news sources NH and many user's terminals UC1, UC2, UC3, . . . . The news sources NH may include, for example, server devices for newsfeeds equipped by newspaper companies, broadcasting stations, etc. In the following description, the user's terminals are comprehensively referred to simply as “UC” when they are not needed to be distinguished individually from one another.

FIG. 1 shows four user's terminals UC, but several tens to several then thousands or more user's terminals may be connected in an actual system. The user's terminal UC is composed of a display screen 1, a keyboard 2 as an input means, a telecommunication function via the network 1, and a browser. The input means 2 may include, for example, a mouse, a microphone and any other appropriate means. It may be used singly or in combination with other means. Although there may be mainly used a personal computer as the user's terminal UC, any appropriate devices such as game machines and portable telephones may also be used as long as they are provided with a display screen, an input means, a telecommunication facility and a browser facility.

From the news sources NH, news is transmitted to the server device SB via the network NW. Once it receives a piece of news, the server device SB saves the news by linking it to what item of what country to which it is related in a manner as will be described later. The news and a piece of news related thereto (one piece of news may be related to a single item or plural items) are saved by the server device SB as a database in such a state that they are linked to each other. As is well known in the art, the server device SB may comprise a large capacity storage device such as a hard disk, etc., a telecommunication facility using a network NW, and a CPU for performing various operations, and can feed XTML files (including images) and XML files.

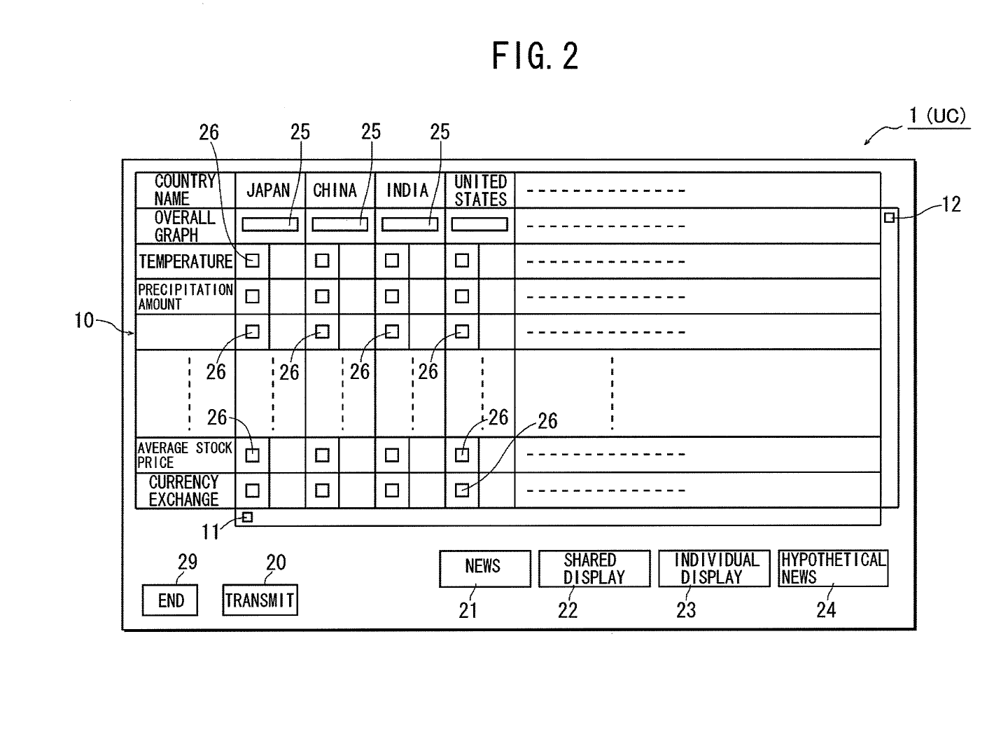

FIG. 2 shows an example of a main window presented by the server device SB as the user's terminal UC is made access to the server device SB. As shown in FIG. 2, a row column 10 displays “country name” on the first row, “total graph” on the second row, as well as items relating to changes of factors regarding the nature such as “temperature”, “precipitation” and items relating to changes of factors regarding human activities such as “mean stock price”, “foreign exchange”, etc. on the fourth row et seq. For instance, the countries can be displayed by operating a scroll button 11 in a horizontal direction to display all the countries set. The items for the factors relating to changes of the nature and human activities can be displayed by scrolling a scroll button 12 in a vertical direction to display an extremely large number of items set.

In addition to those as described above, the changing factors regarding the nature may include, but not be limited to, daylight hours, sea water temperature, moisture and many other matters. Likely, in addition to those as described above, the changing factors regarding the human activities may include, but not be limited to, budget deficit, GDP, birthrate, education diffusion rate, ratio of students advancing to higher education, crime rate and many other matters as items relating to, for example, economy, politics, social affairs, culture, environment, technology, industry and the like. These items may be classified into large-concept categories such as, for example, economy, politics, culture, religion and the like, middle-concept categories as the subordinate categories of the large-concept categories, and small-concept categories as the subordinate categories of the middle-concept categories. It is preferred to set the changing factors by the small-concept categories as many as possible.

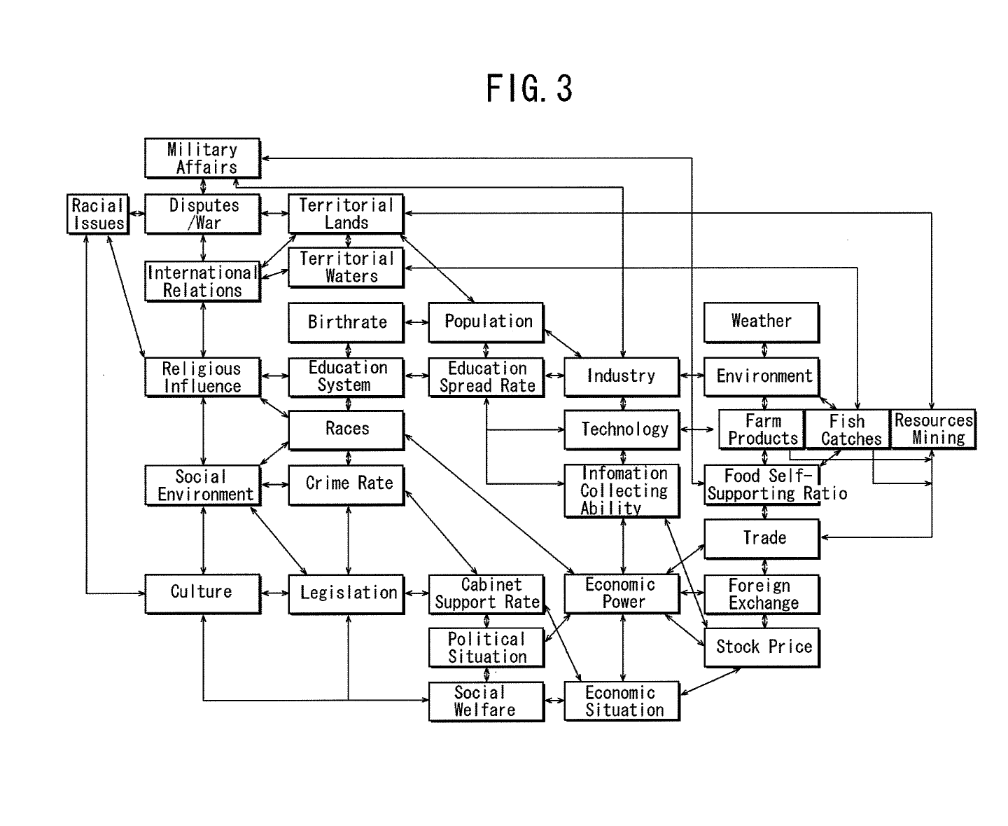

Many items are interrelated with and impacted by one another. For instance, as described above, a rise in prices of iron ores may change the countries and companies producing the iron ores in a good direction, while steel companies and countries consuming the iron ores may change in a bad direction due to a rise in prices of the raw material or iron products. Alternatively, a low level of rain precipitation may cause, for example, a decrease in shipment of agricultural products or desertification, thereby changing in a bad direction. As described above, many items are interrelated with and impacted by many other items or a portion of the items. Such an impact of one item on other item or items may be linked to changes in a good direction or in a bad direction. FIG. 3 reveals a portion of the example in which many items exert an impact on one another.

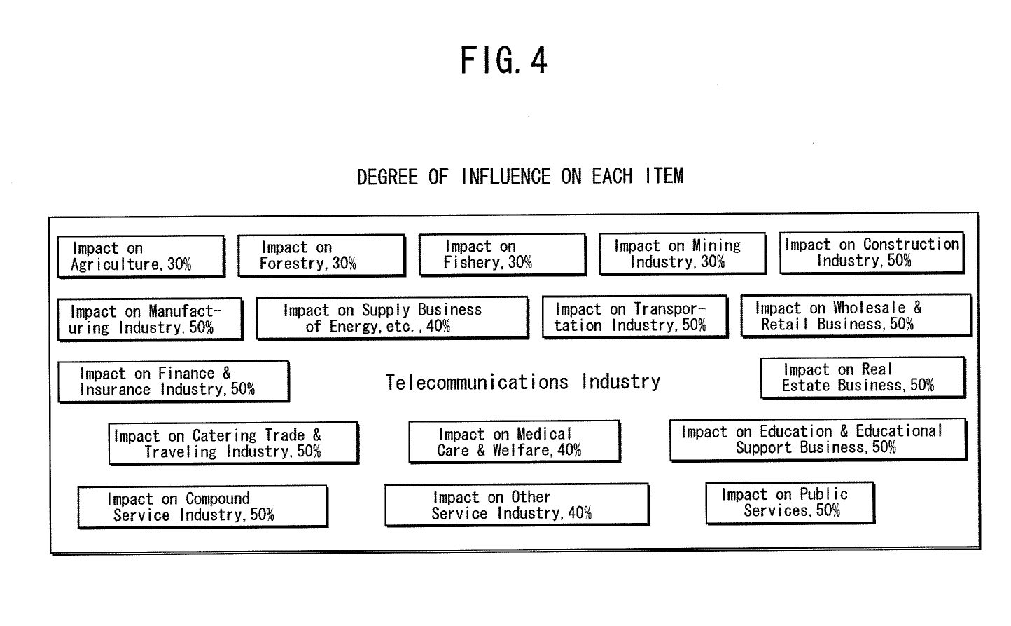

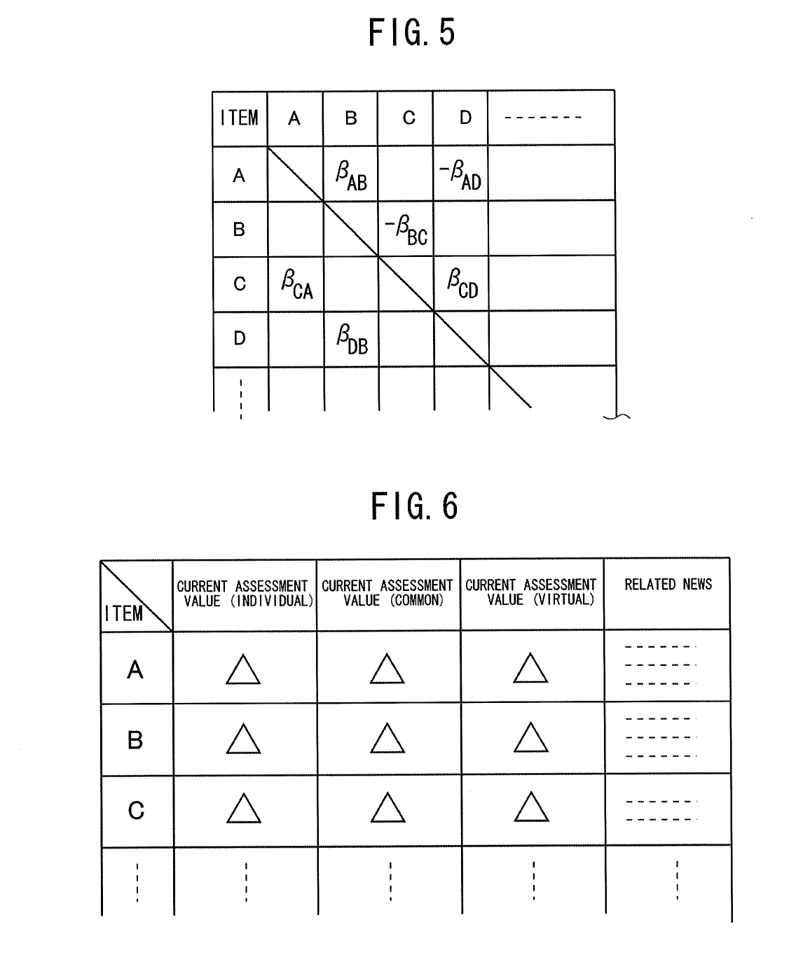

In many cases, the degree of impact of a certain item on another item may change as the item is changed by a different item. FIG. 4 shows an example of the degrees of impact of the network information service industry on other industries. FIG. 5 illustrates an example of databases storing the degrees of impact of many items as represented by reference symbols A, B, C, D, . . . on other items. More specifically, as shown in FIG. 5, for example, item A exerts a degree of impact on item B at a rate of “β_{AB}” and on item D at a rate of “−β_{AD}”. Symbol “β” is intended herein to mean a value in the range of “a value larger than 0 to 1.0” (when “β” is 1.0, the degree of impact is 100%). The subscripts such as AB of the symbol “β” are intended to mean such that the item A exerts an impact on the item B. Likely, the symbol “β_{BC}” means an impact of the item B on the item C.

It is further noted herein that a mark “−” provided in front of the symbol “β” is intended to mean an impact in a bad direction and no mark is intended to mean an impact in a good direction. More specifically, for instance, in the event that the impact of the item A is assessed as “α”, the degree of impact of the item A on the item B is expressed as “β_{AB}” so that this means the item A exerting the impact on the item B in a good direction, while the degree of impact of the item A on the item D is defined as “−β_{AD}” so that this means the item A exerting the impact on the item D in a bad direction.

FIG. 6 shows an example of databases storing current assessment values for each of items A, B, C, . . . . The current assessment value is set in such a manner that the initial value is a predetermined value (for example, a neutral value that is neither good nor bad). Whenever each of many items A, B, C, . . . is assessed as good or bad, the current assessment values of a portion or all of many items change. The database as shown in FIG. 6 sets three current assessment values, e.g., current assessment values for shared users, individual users (particular users), and virtual news. The database for shared users indicates the values reflecting the assessment results made by many users. The database for individual user indicates the value reflecting the assessment result made by the particular user only. The database for the virtual news indicates the values reflecting the assessment results that are not based on any actual news but news made virtually. In accordance with the working example, the current assessment values for the virtual news are indicated as the values reflecting the assessment results made by many users, however, they may be the ones reflecting the assessment results made exclusively by certain particular users. The current assessment values for the virtual news may further be set so as to reflect users shared in common (reflecting the assessment results made by many users) and individual users (reflecting the assessment results made by the particular users). The server's terminals UC may be provided each with, for example, an ID for identifying each of the server's terminals, and the server device SB may be set so as to distinguish each server's terminal US (that is, each user).

The database as shown in FIG. 6 may be set to store a plurality of news exerting a big impact on changes in the current assessment values as related news (for example, top three related news). The related news may be stored generally linking to the database for users shared in common but may be stored linking to the database for the individual users or for the virtual news.

The initial value for the current assessment value stored in the database as shown in FIG. 6 may be set, for example, as “0” for all items. Whenever the current assessment value for each piece of the news is determined on the basis of the assessment made by each user, it may be changed (renewed) in a manner as will be described hereunder. For instance, the upper limit value in the good direction may be set, for example, to “1,000” (i.e., +1,000), while the lower limit value in the bad direction may be set, for example, to “−1,000”. In other words, the changing factor is determined to change in a better direction as the current assessment value is closer to +1,000.

The assessment value “α” indicating the degree of a good/bad assessment by a user is a variant value changing the current assessment value. The assessment value “α” may be set in the following way. The degree of significance is set, for example, to five stages “1 to 5”, inclusive, and the larger value means a higher degree of significance. The assessment value may be set, for example, as “5 stages toward the plus side” or “5 stages toward the minus side” with the central value set to “0”. The word “plus” of the assessment value is intended to mean an assessment in a good direction and the word “minus” of the assessment value is intended to mean an assessment in a bad direction. A piece of news is assessed by a user by selecting both the degree of significance and the assessment. The assessment value “α” is a multiplication of the value indicating the degree of significance and the value indicating the assessment (each of the values being provided with plus or minus except 0). For instance, in the event that the value “3” is selected as the degree of significance and the value “4” is selected as the assessment, the assessment value “α” is computed as “12” (i.e., a multiplication of the value “3” for the degree of significance by the value “4” for the assessment). Similarly, for example, in the event that the value “1” is selected for the degree of significance and the value “−3” is selected for the assessment, the assessment value “α” is set as “−3” (i.e., a multiplication of the value “1” for the degree of significance by the value “−3” for the assessment). The maximal value of the assessment value α per one assessment may be set with the maximal value of the current assessment value taken into consideration. As the ratio of the assessment value α to the maximal value (for example, 1,000) of the current assessment value is larger, the current assessment value is changing rapidly (to a larger extent). The databases as shown in FIGS. 5 and 6 may be stored in the memory means of the server device SB.

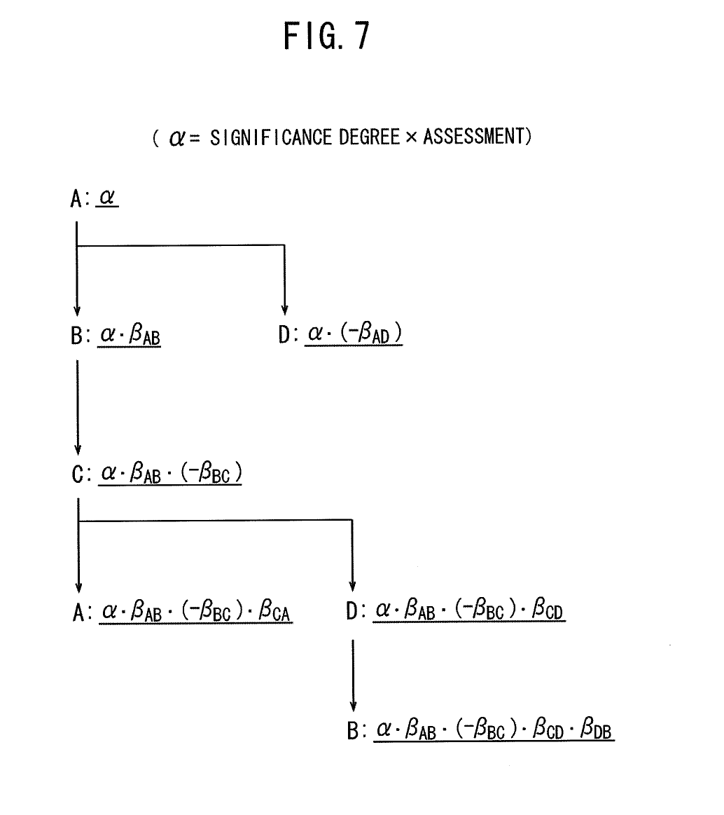

FIG. 7 reveals a process for setting the assessment values of other items B and C impacted by the item A when the assessment result for the item A made by a user is set as the assessment value α. FIG. 7 corresponds to the database as shown in FIG. 5. In FIG. 7, the formula underlined next to each of the items A, B, C, . . . is intended to mean an assessment value. It is to be noted herein that the items are limited only to the items A, B, C, and D as shown in FIG. 5, for brevity of explanation.

First, the assessment result α made by a user is set directly to the item A itself. The assessment value of the item B impacted directly by the item A is set to “α·β_{AB}” obtained by the multiplication of the assessment result “α” by the degree of impact “β_{AB}”. Likely, the assessment value of the item D impacted directly by the item A is set to “α·(−β_{AD})” obtained by the multiplication of the assessment result “α” by the degree of impact “−β_{AD}”. The assessment values of other items may be computed in substantially the same manner.

The item B impacted by the item A may exert an impact on the item C. Therefore, the assessment value of the item C is set to “α·β_{AB}·(−β_{BC})” obtained by the multiplication of the assessment result “α·β_{AB}” of the item B by the degree of impact “−β_{BC}”. Further, the item C may in turn exert an impact on the item A. Therefore, the assessment value of the item A is further set to “α·β_{AB}·(−β_{BC})·β_{CA}” obtained by the multiplication of the assessment value “α·β_{AB}·(−β_{BC})” of the item C by the degree of impact “β_{CA}”. The computation of the assessment values is terminated as the computation for all rows, that is, all items is executed.

The assessment values for the item A, B, C and D computed in the manner as shown in FIG. 7 may be formed in such a manner, for example, that the assessment values for the item A may be formed by two assessment values indicating the assessment value “α” made directly by the user and the assessment value “α·β_{AB}·(−β_{BC})·β_{CA}” impacted by the item C, too, from the impact relationship therewith. As a result, the final assessment value for the item A is set as “α+α˜β_{AB}·(−β_{BC})·β_{CA}” obtained by the addition of all the assessment values of the item A. As shown in FIG. 7, the assessment values for the item are composed of two assessment values. Similarly, the final assessment value for the item B are set to “α·β_{AB}+α·β_{AB}·(−β_{BC})·β_{CD}·β_{DB}”, and the final assessment value for the item C is set to “α˜β_{AB}·(−β_{BC})”. Further, the final assessment value for the item D is set to “α·(−β_{AD})+α·β_{AB}·(−β_{BC})·β_{CD}”. As described above, the assessment value (the final assessment value for each of the items A, B, C and D is added to the current assessment value saved in FIG. 6, thereby renewing the current assessment value. As the assessment value “α” to be used for computing the final assessment value, that is, renewing the current assessment value, the arithmetic mean value of the assessment values made by many users is used for the common database and the assessment value made by a particular user is used intact for the individual database.

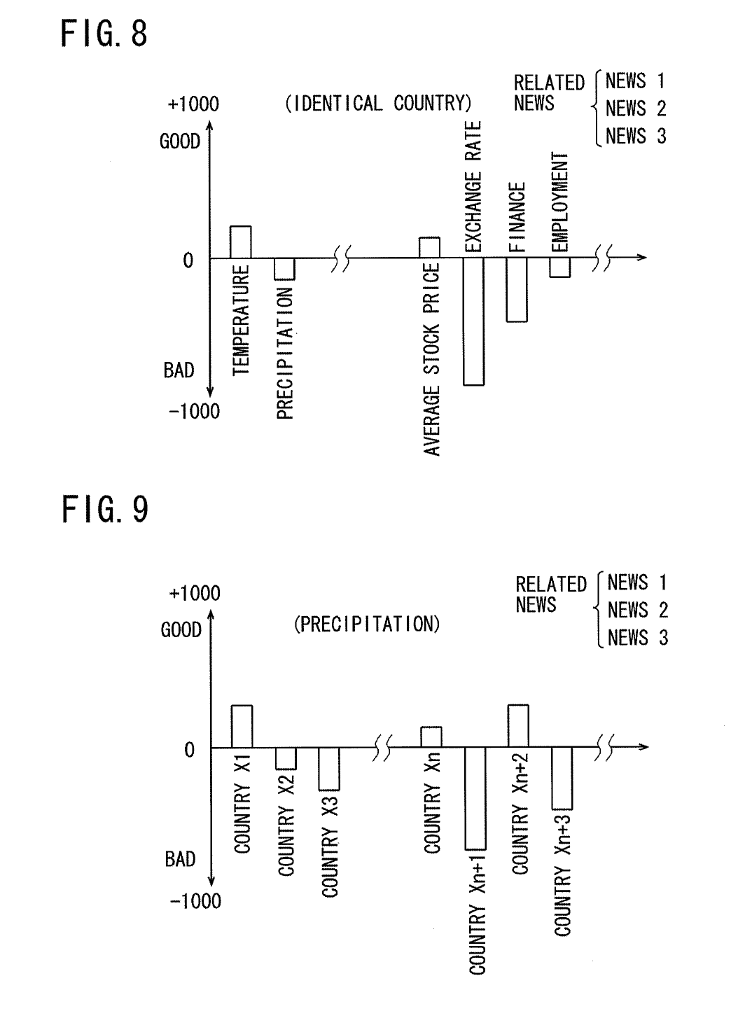

The current assessment values may be displayed on the display screen 1, for example, in the form of a graph according to a selection of a user. As shown in FIG. 2, the current assessment values may be displayed, for example, by first clicking “SHARED DISPLAY” button 22 and then one of “OVERALL GRAPH” buttons 25 for selecting the country of interest, followed by clicking “TRANSMIT” button 20 to transmit to the server device SB a signal for requiring a transmission of the current assessment value of the content selected above. Upon the receipt of the transmission requirement signal, the server device SB then transmits the current assessment value of the selected content to the server's terminal UC and the transmitted current assessment value of the selected content is then displayed on the display screen 1 of the server's terminal US in a manner, for example, as shown in FIG. 8. For instance, FIG. 8 shows a bar graph of the good/bad current assessment values for many items of a certain country selected (for example, Japan as the identical country). By clicking a button 26 for selecting an item of interest instead of the OVERALL GRAPH button 25, the current assessment values of the overall countries relating to the clicked item may be displayed in a manner as shown in FIG. 9 which in turn shows good/bad current assessment values of each country, for example, for an item of “precipitation” in the form of a bar graph.

The current assessment values stored and renewed in the database for individual users may be displayed by clicking “INDIVIDUAL DISPLAY” button 23 in the above description, instead of the SHARED DISPLAY button 22. Likely, the current assessment values stored and renewed in the database for virtual news may be displayed by clicking “HYPOTHETICAL NEWS” button 24 instead of the SHARED DISPLAY button 22.

The current assessment values may be displayed for middle-concept items compiling small-concept items. The current assessment values for the middle-concept items may be provided, for instance, by subjecting the current assessment values for plural small-concept items contained in the middle-concept items out of many small-concept items (corresponding to the items A, B, C, . . . as shown in FIGS. 5 to 7) to an arithmetic mean. In this case, many small-concept items may be weighed among one another to compute the current assessment values for the middle-concept items.

The current assessment values for large-concept items compiling the middle-concept items may be displayed in substantially the same manner as described above. In this case, the current assessment values for the large-concept items may be obtained, for example, by subjecting the current assessment values for all the small-concept items contained in the large-concept items to an arithmetic mean. The small-concept items may be weighed among many small-concept items to compute the current assessment values for the large-concept items. The items may be appropriately set by classifying items into three stages, i.e., large, middle and small, as well as one stage, two stages, four stages or more.

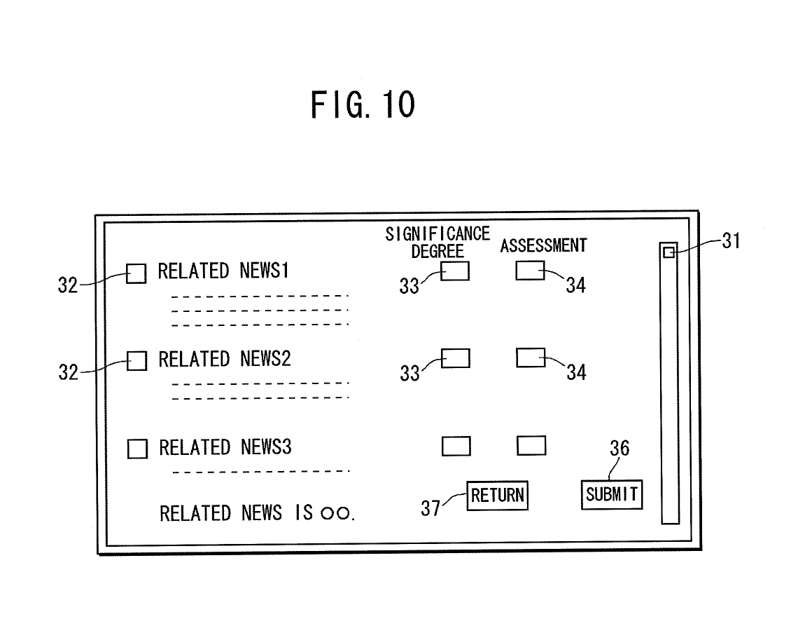

Next, a description will be made hereinafter regarding a news feed requirement for feeding news (related news) and assessment with reference to FIGS. 2 and 10. Referring to FIG. 2, the feeding of a piece of news may be required, for example, by first clicking “NEWS” button 21 and then a button 26 corresponding to one of the items relating to temperature, rain precipitation, etc. of a certain country, followed by clicking the TRANSMIT button 20 to transmit a transmission requirement signal for related news corresponding to the country and the item clicked by the button to the server device SB. Upon the receipt of the transmission requirement signal, the server device SB transmits the news relating to the selected country and news to user's terminals UC and displays the related news on the display screen 1, for example, in a manner as shown in FIG. 10. In the event that there are plural related news, they may be displayed in numerical order of the related news, such as news 1, news 2, . . . . The related news that cannot be displayed on the display screen may be displayed by operating “VERTICAL SCROLL” button 31 to scroll the related news in a vertical direction. FIG. 10 may also display the related news relating to the news of interest.

For each of the related news as shown in FIG. 10, there are provided a choice box 32 for selecting the related news of interest at the left side thereof as well as choice boxes 33 and 34 for selecting degree of significance and assessment, respectively, at the right side thereof. By checking the choice box 32 corresponding to the related news of interest for assessment, a user may input a value indicating the degree of significance in the choice box 33 and a value indicating the assessment in the choice box 34. Another piece of related news may be selected and assessed by repeating the operations as described above. At the end of the operations, the “TRANSMIT” button 36 is clicked to transmit the selected related news as well as its assessment result (degree of significance and assessment) in a linked state to the server device SB.

Referring to FIG. 10, the “RETURN” button 37 is clicked to return the display screen to the main screen as shown in FIG. 2. The display terminates by clicking the “END” button 29.

The virtual news may be formed and assessed on the side of the user's terminal UC, and the assessment result may be transmitted to the server device SB. Referring to FIG. 2, the “HYPOTHETICAL NEWS” button 24 is clicked followed by clicking the button 26 corresponding to the related item relating to the virtual news, thereby displaying a window corresponding to FIG. 10 on the display screen of a user's terminal UC. The display screen displays a column for forming virtual news as well as columns for checking a degree of significance and an assessment value in addition to the display of the related items. The required matters are then entered into the columns involved and the “TRANSMIT” button is clicked to transmit the virtual news of interest, its related items, and its assessment results to the server device SB. As a matter of course, the contents received by the server device SB may be used, for example, for renewing the current assessment values in the database for virtual news.

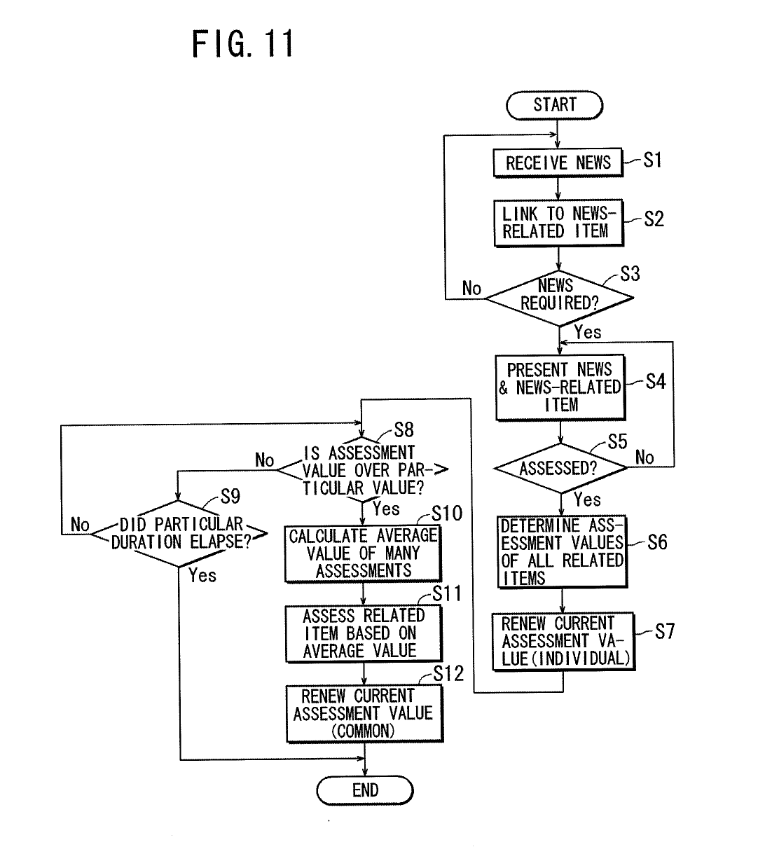

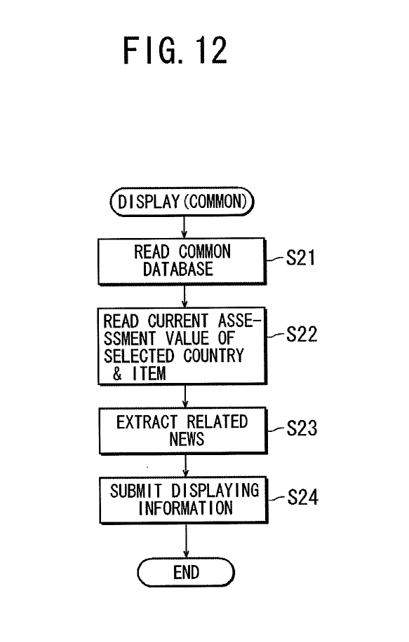

FIGS. 11 and 12 show flowcharts indicating the control contents to be controlled by the server device SB. In the description regarding those flowcharts, reference symbol “S” is intended to mean a step. In S1 of FIG. 11, a piece of news is received through a network NW from a news source NH and, in S2, it is then linked to items relating to the received news and stored as a database. The received news may be linked, for example, by analyzing words (particularly significant words) contained in the news and setting items containing such words or items having a high degree of relations with the words as related news. It is to be noted herein that plural related items may be set for one piece of news.

After S2, it is determined in S3 whether a feeding of news is required from a user's terminal UC. If the determination is NO in S3, on the one hand, the flow is returned to S1. If the determination is YES in S3, on the other hand, the flow goes to S4 where the news is linked to related item or items, followed by transmitting them to the user's terminal UC. They may be displayed on the display screen 1 of the user's terminal UC in such a manner as shown in FIG. 10.

After S4, the flow goes to S5 where it is determined whether the assessment result is received from the user's terminal UC. It the determination is NO in S5, the flow returns to S4. If the determination is YES in S5, the assessment values are computed for the related items directly related to the news of interest and all other items relating to the related item or items in S6 (by executing the assessment in a manner as shown in FIG. 7). Thereafter, the current assessment values for the database for individual users may be renewed by the assessment values computed in S6.

After S7, the flow goes to S8 where it is determined whether a number of assessments for the news as an object of current assessment is larger than a predetermined number (for example, 50). After all, it is determined in S8 whether a piece of news is assessed by more than the predetermined number of users. If it is determined as NO in S8, the flow goes to S9 where it is determined whether a predetermined period of time (for example, 48 hours) has elapsed from the start of first feeding the news. When the determination is NO in S9, the flow returns to S8.

When it is determined as YES in S8, the flow goes to S10 where a mean value is computed by subjecting more than the predetermined number of the assessment values to an arithmetic mean, followed going to S11 at which the assessment values is computed for all the related news on the basis of the mean value computed in S10 (corresponding to S6). Thereafter, in S12, the current assessment values of the database for shared users are renewed by the assessment value of each item computed in S11 (corresponding to S7). If the determination in S9 is YES, the flow terminates as it is. This means that the predetermined number of the assessment values was not obtained during a predetermined period of time so that the current assessment values of the database for shared users are not renewed.

As the END button 29 in FIG. 2 is clicked, the control of FIG. 11 terminates. The assessment and the current assessment values on the basis of the virtual news are executed in the same manner as above so that a description regarding the execution thereof is omitted herein.

FIG. 12 shows an example for controlling the display of the current assessment values on the display screen 1. FIG. 12 corresponds to the clicking of the SHARED DISPLAY button 22 as shown in FIG. 2 to control the display of the current assessment values in the database for shared users. First, in S21, the database for shared users is read in, followed by going to S22 where the current assessment values for the country and the items of interest as an object required for display by the user are extracted from the database for shared users. Then, in S23, news exerting a big impact on a variation in the read current assessment values is extracted, followed by going to S24 at which the contents extracted in S22 and S23 are transmitted to a user's terminal UC and displayed in such a manner as shown in FIGS. 8 and 9, respectively.

The above description is made regarding working examples, but the present invention is not limited to the working examples as described above and may be modified in an appropriate fashion within the scope of the claims as described herein, for example, including embodiments as will be described herein. In the working examples, almost all countries are set as an object of the country for assessment, but a portion of countries or one country may also be set as an object for assessment. Moreover, in setting a multitude of items, an area smaller than a country including, for example, Tokyo Prefecture, a city, town, village or the like or an organization including, for example, a company or a school, may be set as an object for assessment. The smaller the scope of the area to be set for an item is, the more familiar and smaller news can be provided because the scope of users is limited. Such news may be utilized, for example, for improvements in environment and so on.

As many items to be set, either one of the changing factors regarding the nature or human activities may be set. However, as the changing factors regarding the nature are recently closely interrelated with the changing factors based on the human activities, it is deemed preferred to set items for both of the changing factors as many as possible. The current assessment values may also be displayed in various manners including, for example, utilizing a map. More specifically, for example, the countries may be displayed on a world map and classified as good or bad in different colors. Alternatively, areas of a country may be displayed by distinguishing them from one another on a map of the country and classified as good or bad in different colors.

The present invention also provides a program for controlling the simulation device in the manner as shown in FIGS. 11 and 12. The roles shared by the user's terminals US and the server device SB may be changed in such a manner that, for instance, the server device SB plays a role solely in feeding news and related news while the user's terminals UC play a role in performing controls other than the control of feeding the news and the related news (for example, the control corresponding to the control to be made in S3 et seq. of FIG. 11). In this case, the control program may be downloaded in the user's terminals UC from the server device SB. Moreover, the user's terminals UC may be provided with all the functions of the server device SB. It may be noted herein that the object of the present invention also provides matters encompassed in an implied sense as being substantially good or as merits in addition to those specified in a clearly expressed manner.

### INDUSTRIAL APPLICABILITY

The present invention can simulate a good/bad impact on many items given by news.

1. A simulation device comprising:
a memory means for saving as a database a current assessment value for a multitude of items as being good or bad regarding at least one of changing factors regarding the nature and changing factors based on human activities set as well as a correlation of degrees of impact of an item on other items in a good or bad direction among said multitude of items;
a news provision means for providing a user's display screen with a piece of news and an item related thereto among the multitude of items in a state in which the item related thereto is linked as a news-related item;
an assessment input means for entering a degree of assessment made by a user as to whether the provided news exerts a good or bad impact on the news-related item;
an assessment value renewal means for renewing said current assessment value for said news-related item on the basis of an assessment result entered and renewing said current assessment value for another item relating to the news-related item on the basis of the assessment result and the degree of impact; and
an assessment display means for displaying the saved current assessment value on the display screen.

2. The simulation device as claimed in claim 1, further comprising a mean assessment value determination step for determining a mean value of plural degrees of assessments made for a piece of news by plural users;
wherein said assessment value renewal means renews a current assessment value on the basis of said mean value.

3. The simulation device as claimed in claim 1, further comprising a mean assessment value determination step for determining a mean value of plural degrees of assessments for a piece of news made by plural users;
wherein said database comprises an exclusive database exclusive for particular users which saves current assessment values for particular users and a common database for a multitude of users shared in common which saves current assessment values for shared users; and
wherein said assessment value renewal means renews said current assessment values on the basis of an input of a degree of assessment by the particular user using the exclusive database and said current assessment values based on the degrees of assessments by the plural users on the basis of the mean assessment value determination step using the common database for the shared users.

4. The simulation device as claimed in claim 1, wherein said database further comprises a virtual database for virtual news saving a current assessment value for a virtual news; and
said assessment value renewal step renews the current assessment value for the virtual news when a degree of assessment for the virtual news is entered by said assessment input means.

5. The simulation device as claimed in claim 1, wherein:
a server device is connected to a multitude of user's terminals equipped each with said display screen via a communication means;
the server device comprises said memory means, said news provision means and said assessment value renewal means;
news, the news-related item and the current assessment value are transmitted to the user's terminals via said communication means from said server device; and
said degree of assessment is transmitted via said communication means from the user's terminal.

6. The simulation device as claimed in claim 1, wherein:
said multitude of items are set for both of changing factors regarding the nature and changing factors by human activities per each country;
said correlation is set among a multitude of items for plural countries; and
the current assessment value to be displayed by said assessment value display means is selectable from a display manner for displaying a portion of items for each country and a display manner for displaying a multitude of items for one country.

7. A program for operating a simulation device to execute a computer for simulating a current assessment value as to whether each of a multitude of items is good or bad, said items being set for at least one of factors changing regarding the nature and factors changing by a human activity, wherein:
a news provision step for providing a display screen with a piece of news and an item relating thereto among a multitude of items in such a state that the item relating thereto is linked as a news-related item;
an assessment input reception step for receiving an input of a degree of assessment as to whether an impact of the provided news on the news-related item is good or bad;
an assessment value renewal step for renewing the current assessment value of the news-related item on the basis of the assessment result entered and the current assessment value for another item relating to the news-related item on the basis of the assessment result and the degree of impact by checking the database storing a correlation of degrees of impact of an item on another item as to whether the impact of the item on said another item is good or bad; and
a display step for displaying the stored current assessment value on the display screen.

8. The program for operating the simulation device as claimed in claim 7, wherein:
a mean assessment step is provided for determining a mean of plural degrees of assessment for a piece of news entered by plural users;
said database comprises an exclusive database storing the current assessment value exclusively for a particular user and a common database storing the current assessment value for plural users shared in common; and
the assessment value renewal step for renewing the current assessment value for the exclusive database on the basis of an input of an assessment degree by the particular user and renewing the current assessment value for the common database based on the assessment degrees entered by the plural users on the basis of the mean value determined by the mean assessment value determination means.
